(19) United States
(12) Patent Application Publication
(10) Pub. No.: US 2026/0319142 A1
(43) Pub. Date: Oct. 15, 2026

(54) OPTICAL LENS AND OPTICAL WAVEGUIDE STRUCTURE INCLUDING THE SAME

(71) Applicant: VisEra Technologies Company Limited, Hsin-Chu City (TW)

(72) Inventors: Hsueh-Yu LU, Hsin-Chu City (TW); Peng-Hao CHEN, Hsin-Chu City (TW); Hsien-Chih LAI, Hsin-Chu City (TW); Jiun-Yi LIEN, Hsin-Chu City (TW); Yi-Hsun CHIU, Hsin-Chu City (TW)

(21) Appl. No.: 19/174,324

(22) Filed: Apr. 9, 2025

(51) Int. Cl. G02B 3/08; G02B 3/00

(52) U.S. Cl. CPC G02B 3/08; G02B 3/0087

(57) ABSTRACT

An optical lens is provided. The optical lens includes a substrate and a dielectric layer disposed on the substrate. The dielectric layer includes a flat portion and a gradient portion disposed on the flat portion. The flat portion has a constant thickness, and the gradient portion has a continuously varying thickness. The optical lens further includes a waveguide layer disposed on the dielectric layer. The waveguide layer includes a multi-ridged waveguide element that corresponds to the gradient portion.

### BACKGROUND OF THE INVENTION

### Field of the Invention

The present disclosure relates to an optical lens and an optical waveguide structure including the optical lens, and, in particular, to an optical lens that includes a gradient portion and an optical waveguide structure including the optical lens.

### Description of the Related Art

The quality of the visual output of current optical devices, particularly those used in augmented reality (AR), virtual reality (VR), and mixed reality (MR), is highly dependent on the uniformity and profile of the optical waveguide structure. The total thickness variation (TTV) of the optical waveguide structure plays a critical role in maintaining optical efficiency, as any deviation from the optimal TTV can lead to distortions or reductions in image clarity. Traditional methods for achieving precise TTV control involve the polishing of substrates, particularly for gradient wedge glass wafers. However, these methods are both cost-intensive and time-consuming, as they demand high precision and extensive processing. Consequently, there is a need for an efficient and reliable solution to maintain TTV within the desired parameters without resorting to these laborious polishing methods.

### BRIEF SUMMARY OF THE INVENTION

In some embodiments of the present disclosure, the optical lens includes a gradient portion in the dielectric layer or in the substrate, which may effectively control the TTV of the waveguide layer for improving the optical efficiency. In may also avoid expensive polishing steps or other less-efficient methods for controlling the TTV of the waveguide material after the formation of the waveguide layer.

An embodiment of the present disclosure provides an optical lens. The optical lens includes a substrate and a dielectric layer disposed on the substrate. The dielectric layer includes a flat portion and a gradient portion disposed on the flat portion. The flat portion has a constant thickness, and the gradient portion has a continuously varying thickness. The optical lens further includes a waveguide layer disposed on the dielectric layer. The waveguide layer includes a multi-ridged waveguide element that corresponds to the gradient portion.

In some embodiments, the gradient portion defines a slope surface, and the dihedral angle between the slope surface and the top surface of the substrate is greater than 0.0010 and less than 0.01°.

In some embodiments, the maximum thickness of the gradient portion is within a range of 1 μm to 2 μm.

In some embodiments, the thickness of the flat portion is within a range of 1 μm to 18 μm.

In some embodiments, the ratio of the refractive index of the dielectric layer to the refractive index of the substrate is within a range of 0.95 to 1.05.

In some embodiments, the refractive index of the dielectric layer is within a range of 1.5 to 2.8.

In some embodiments, in a cross-sectional view, the width of the gradient portion is within a range of 40 mm to 60 mm.

In some embodiments, the optical lens further includes at least one additional layer disposed between the substrate and the dielectric layer.

In some embodiments, the additional layer includes an adhesion layer, a flatness layer, or a refractive index matching layer.

In some embodiments, the multi-ridged waveguide element is a surface relief grating or a meta-lens.

In some embodiments, the multi-ridged waveguide element includes multiple protrusions, and the protrusions form multiple cavities.

In some embodiments, in a cross-sectional view, the width of each protrusions is within a range of 100 nm to 300 nm.

In some embodiments, in a cross-sectional view, the pitch of the protrusions is within a range of 200 nm to 600 nm.

In some embodiments, the depth of the cavities is within a range of 20 nm to 200 nm.

In some embodiments, the thickness of the substrate is within a range of 0.2 mm to 1 mm.

In some embodiments, the refractive index of the substrate is within a range of 1.5 to 2.8.

An embodiment of the present disclosure provides an optical lens. The optical lens includes a substrate that includes a flat portion and a gradient portion disposed on the flat portion. The flat portion has a constant thickness, and the gradient portion has a continuously varying thickness. The optical lens further includes a waveguide layer disposed on the substrate. The waveguide layer includes a multi-ridged waveguide element that corresponds to the gradient portion.

In addition, an embodiment of the present disclosure provides an optical waveguide structure. The optical waveguide structure includes a substrate and a dielectric layer disposed on the substrate. The dielectric layer includes a flat portion and at least one gradient portion disposed on the flat portion. The flat portion has a constant thickness, and the gradient portion has a continuously varying thickness. The optical waveguide structure further includes a waveguide layer disposed on the dielectric layer. The waveguide layer includes multi-ridged waveguide elements.

In some embodiments, the gradient portion includes gradient portions, and the multi-ridged waveguide elements correspond to the gradient portions.

In some embodiments, the maximum thickness of the gradient portion is within a range of 8 μm to 10 μm.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a partial top view illustrating the optical waveguide structure according to some embodiments of the present disclosure.

FIG. 2 is a partial cross-sectional view illustrating the optical waveguide structure according to some embodiments of the present disclosure.

FIG. 3 is a partially enlarged cross-sectional view illustrating the optical lens according to some embodiments of the present disclosure.

FIG. 4A to FIG. 4D are partial cross-sectional views illustrating the method for manufacturing the optical waveguide structure at various stages according to some embodiments of the present disclosure.

FIG. 5 is a partial cross-sectional view illustrating the optical waveguide structure according to some other embodiments of the present disclosure.

FIG. 6A to FIG. 6B are partial cross-sectional views illustrating the method for manufacturing the optical waveguide structure at various stages according to some other embodiments of the present disclosure.

FIG. 7 and FIG. 8 are partial cross-sectional views illustrating the optical waveguide structures according to some other embodiments of the present disclosure.

FIG. 9 is a partial cross-sectional view illustrating the optical waveguide structure according to some other embodiments of the present disclosure.

FIG. 10A to FIG. 10C are partial cross-sectional views illustrating the method for manufacturing the optical waveguide structure at various stages according to some other embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean+/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

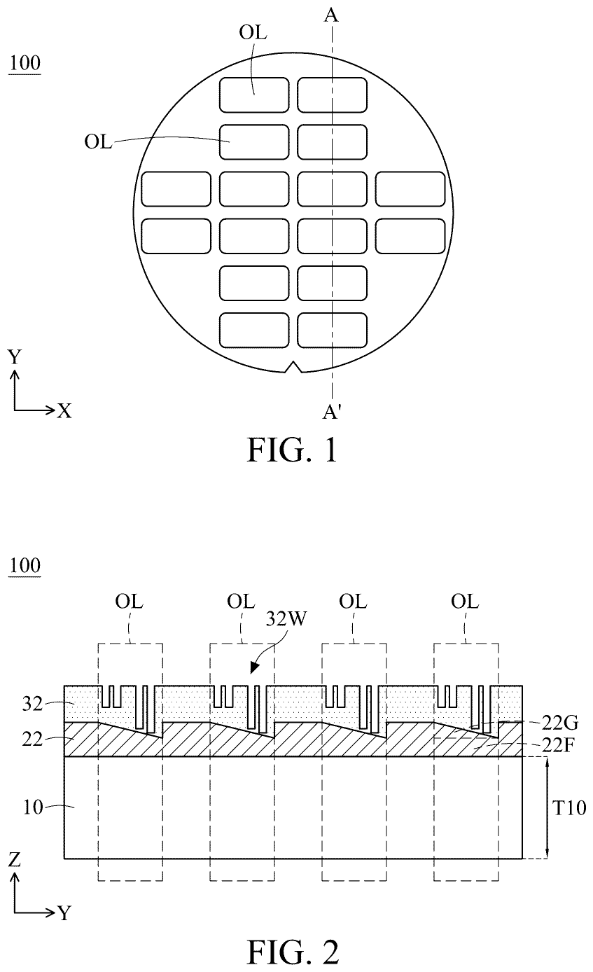

FIG. 1 is a partial top view illustrating the optical waveguide structure 100 according to some embodiments of the present disclosure. FIG. 2 is a partial cross-sectional view illustrating the optical waveguide structure 100 according to some embodiments of the present disclosure. For example, FIG. 2 may be a partial cross-sectional view of the optical waveguide structure 100 along line A-A′ in FIG. 1, but the present disclosure is not limited thereto. It should be noted that some components of the optical waveguide structure 100 have been omitted in FIG. 1 and FIG. 2 for the sake of brevity.

As shown in FIG. 1 and FIG. 2, the optical waveguide structure 100 includes multiple optical lenses OL. In the top view shown in FIG. 1, each optical lens OL may be formed as a rectangle (or quasi-rectangle), and the multiple optical lenses OL are arranged symmetrically, but the present disclosure is not limited thereto. The optical lenses OL may also be formed as an irregular shape, which may depend on actual needs.

Referring to FIG. 2, in some embodiments, the optical waveguide structure 100 includes a substrate 10. For example, the substrate 10 may be a glass substrate or any other transparent substrate. In some embodiments, the thickness T10 of the substrate 10 is within a range of about 0.2 mm to about 1 mm.

The optical waveguide structure 100 also includes a dielectric layer 22 disposed on the substrate 10. As shown in FIG. 2, the dielectric layer 22 includes a flat portion 22F and multiple gradient portions 22G disposed on the flat portion 22F. Moreover, the flat portion 22F has a constant thickness, and each gradient portion 22G has a continuously varying thickness. For example, the dielectric layer 22 may include any suitable dielectric material, such as silicon oxide, silicon nitride, silicon oxynitride, low-x dielectric material, aluminum oxide, aluminum nitride, the like, or a combination thereof, but the present disclosure is not limited thereto.

In some embodiments, the refractive index of the dielectric layer 22 is within a range of about 1.5 to about 2.8. Moreover, in this embodiment, the ratio of the refractive index of the dielectric layer 22 to the refractive index of the substrate 10 is within a range of about 0.95 to about 1.05. In other words, the difference between the refractive index of the dielectric layer 22 and the refractive index of the substrate 10 may be within about ±5%. In some embodiments, the refractive index of the substrate 10 is also within a range of about 1.5 to about 2.8, but the present disclosure is not limited thereto.

Referring to FIG. 2, in some embodiments, the optical waveguide structure 100 further includes a waveguide layer 32 disposed on the dielectric layer 22, and the waveguide layer 32 includes multiple multi-ridged waveguide elements 32W. In some embodiments, the multi-ridged waveguide elements 32W correspond to the gradient portions 22G. For example, the multi-ridged waveguide elements 32W may be aligned with the gradient portions 22G, but the present disclosure is not limited thereto.

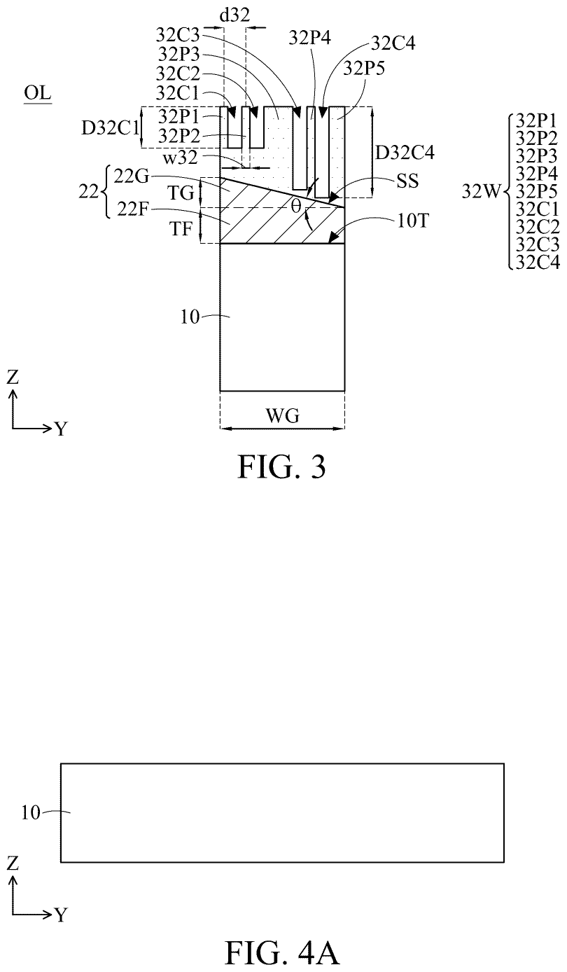

The optical waveguide structure 100 may be divided into multiple optical lenses OL. FIG. 3 is a partially enlarged cross-sectional view illustrating the optical lens OL according to some embodiments of the present disclosure. As shown in FIG. 2 and FIG. 3, in some embodiment, the optical lens OL includes a substrate 10 and a dielectric layer 22 disposed on the substrate 10. The dielectric layer 22 includes a flat portion 22F and a gradient portion 22G disposed on the flat portion 22F. The flat portion 22F has a constant thickness, and the gradient portion 22G has a continuously varying thickness. The optical lens OL further includes a waveguide layer 32 disposed on the dielectric layer 22. The waveguide layer 32 includes a multi-ridged waveguide element 32W that corresponds to the gradient portion 22G.

As shown in FIG. 3, in some embodiments, the gradient portion 22G defines a slope surface SS, and the dihedral angle θ between the slope surface SS and the top surface 10T of the substrate 10 is greater than about 0.0010 and less than about 0.01°. Here, the dihedral angle θ may be defined as

$${tan}^{- 1} \frac{maximum thickness TG of the gradient portion TG}{width WG of the gradient portion TG in a cross - sectional view} .$$

In some embodiments, the maximum thickness TG of the gradient portion 22G is within a range of about 1 μm to about 2 μm. In some embodiments, the width WG of the gradient portion 22G is within a range of about 40 mm to about 60 mm in a cross-sectional view (e.g., the cross-sectional view shown in FIG. 3). The maximum thickness TG of the gradient portion 22G may control the total thickness variation (TTV) of the optical lens OL (or the optical waveguide structure 100) for improving the optical efficiency.

Moreover, in some embodiments, the thickness TF of the flat portion 22F is within a range of about 1 μm to about 18 μm. In other words, the maximum total thickness of the dielectric layer 22 (i.e., maximum thickness TG of the gradient portion 22G and thickness TF of the flat portion 22F) may be about 2 μm to about 20 μm, but the present disclosure is not limited thereto.

In some embodiments, the multi-ridged waveguide element 32W is a surface relief grating or a meta-lens. As shown in FIG. 3, in this embodiment, the multi-ridged waveguide element 32W includes multiple protrusions 32P1, 32P2, 32P3, 32P4, and 32P5, and the protrusions 32P1, 32P2, 32P3, 32P4, and 32P5 form multiple cavities 32C1, 32C2, 32C3, and 32C4. Here, the protrusions 32P1, 32P2, 32P3, 32P4, and 32P5 are protruded from the substrate 10. It should be noted that the number of protrusions and the number of cavities may be adjusted according to actual needs. This configuration modifies the propagation characteristics for specialized applications.

As shown in FIG. 3, the width of the protrusions 32P1, 32P2, 32P3, 32P4, and 32P5 may be variable. In some embodiments, the width w32 of the protrusion 32P1, 32P2, 32P3, 32P4, or 32P5 is within a range of about 100 nm to about 300 nm in a cross-sectional view (e.g., the cross-sectional view shown in FIG. 3). Moreover, the pitch d32 of the protrusions 32P1, 32P2, 32P3, 32P4, and 32P5 (i.e., the distance between central lines of two adjacent protrusions) is variable. In some embodiments, the pitch d32 of the protrusions 32P1, 32P2, 32P3, 32P4, and 32P5 is within a range of about 200 nm to about 600 nm in a cross-sectional view (e.g., the cross-sectional view shown in FIG. 3).

As shown in FIG. 3, the thicknesses of the protrusions 32P1, 32P2, 32P3, 32P4, and 32P5 may be different. Therefore, the depths of the cavities 32C1, 32C2, 32C3, and 32C4 may be different. For example, as shown in FIG. 3, the depth D32C1 of the cavities 32C1 may be less than the depth D32C4 of the cavities 32C4, but the present disclosure is not limited thereto. In some embodiments, the depth (D31 or D32) of the cavities 32C1, 32C2, 32C3, and 32C4 is within a range of about 20 nm to about 200 nm.

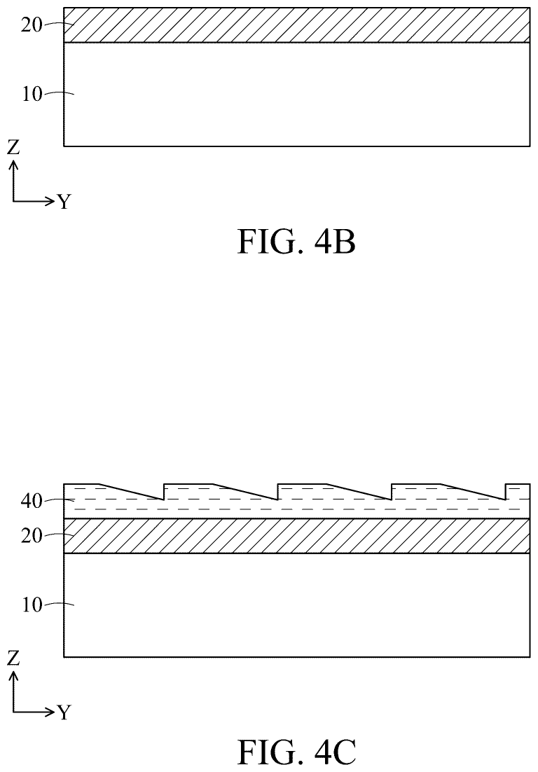

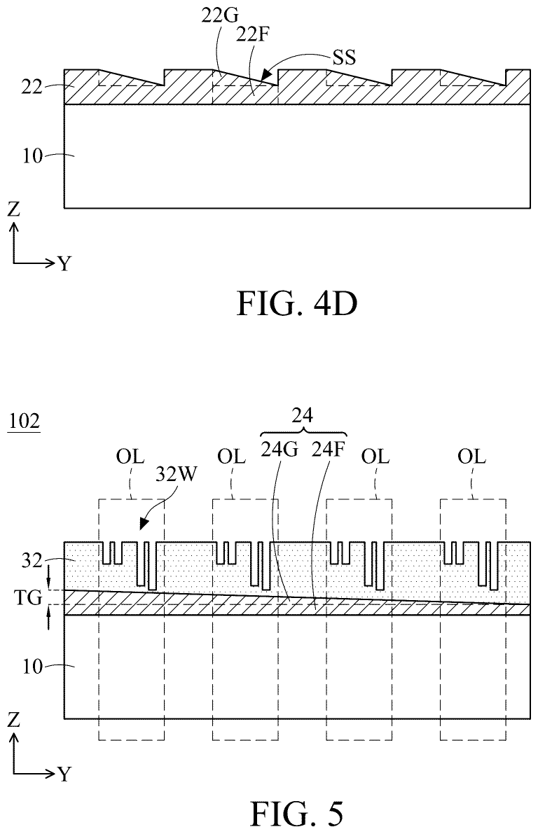

FIG. 4A to FIG. 4D are partial cross-sectional views illustrating the method for manufacturing the optical waveguide structure 100 at various stages according to some embodiments of the present disclosure. It should be noted that some steps during the method for manufacturing the optical waveguide structure 100 and/or some components of the optical waveguide structure 100 have been omitted in FIG. 4A to FIG. 4D for the sake of brevity.

As shown in FIG. 4A, a substrate 10 (e.g., glass) is provided. Then, as shown in FIG. 4B, a dielectric material 20 is formed on the substrate 10. For example, the dielectric material 20 may be formed by a deposition process, such as a chemical vapor deposition (CVD) process, an atomic layer deposition (ALD) process, a spin coating process, the like, or a combination thereof, but the present disclosure is not limited thereto.

Next, as shown in FIG. 4C, a mask layer 40 is formed on the dielectric material 20. In this embodiment, the mask layer 40 has a plurality of slope surfaces. For example, the mask layer 40 may be a photoresist, such as a positive photoresist or a negative photoresist. In more detail, the mask layer 40 may include a hard mask and may include silicon oxide (SiO₂), silicon nitride (SiN), silicon oxynitride (SiON), silicon carbide (SiC), silicon carbonitride (SiCN), the like, or a combination thereof.

Moreover, the mask layer 40 may be formed by a deposition process, a photolithography process, any other suitable process, or a combination thereof. For example, the deposition process may include spin-on coating, CVD, ALD, the like, or a combination thereof; the photolithography process may include photoresist coating (e.g., spin coating), soft baking, mask aligning, exposure, post-exposure baking (PEB), developing, rinsing, drying (for example, hard baking), any other suitable process, or a combination thereof, but the present disclosure is not limited thereto.

Then, as shown in FIG. 4D, an etching process is performed to etch the dielectric material 20 to form the dielectric layer 22 using the mask layer 40 as an etch mask, so that the dielectric layer 22 includes a flat portion 22F and gradient portions 22G disposed on the flat portion 22F. As shown in FIG. 4D, in this embodiment, the flat portion 22F has a constant thickness, each gradient portion 22G has a continuously varying thickness and defines a slope surface SS. The etching process may include a dry etching process, a wet etching process, or a combination thereof. For example, the dry etching process may include reactive ion etch (RIE), inductively-coupled plasma (ICP) etching, neutral beam etch (NBE), electron cyclotron resonance (ERC) etching, the like, or a combination thereof. The wet etching process may use, for example, hydrofluoric acid (HF), ammonium hydroxide (NH₄OH), or any suitable etchant.

Next, as shown in FIG. 2, a waveguide layer 32 is formed on the dielectric layer 22 to form the optical waveguide structure 100. As shown in FIG. 2, the waveguide layer 22 includes multiple multi-ridged waveguide elements 32W that correspond to the gradient portions 22G. In some embodiments, the optical waveguide structure 100 is then divided into a plurality of optical lens OL according to the slope surfaces SS of the gradient portions 22G.

FIG. 5 is a partial cross-sectional view illustrating the optical waveguide structure 102 according to some other embodiments of the present disclosure. The top view of the optical waveguide structure 102 may be similar to the top view of the optical waveguide structure 100. That is, FIG. 5 may also be a partial cross-sectional view of the optical waveguide structure 100 along line A-A′ in FIG. 1, but the present disclosure is not limited thereto. Similarly, some components of the optical waveguide structure 102 have been omitted in FIG. 5 for the sake of brevity.

As shown in FIG. 5, in some embodiments, the optical waveguide structure 102 includes a substrate 10 and a dielectric layer 24 disposed on the substrate 10. The dielectric layer 24 includes one flat portion 24F and one gradient portion 24G disposed on the flat portion 24F. The flat portion 24F has a constant thickness, and the gradient portion 24G has a continuously varying thickness. The optical waveguide structure 102 further includes a waveguide layer 32 disposed on the dielectric layer 24, and the waveguide layer 32 includes multiple multi-ridged waveguide elements 32W.

In this embodiment, the maximum thickness TG of the gradient portion 24G is within a range of about 8 μm to about 10 μm. Moreover, the optical waveguide structure 102 may be divided into a plurality of optical lens OL according to the multi-ridged waveguide elements 32W.

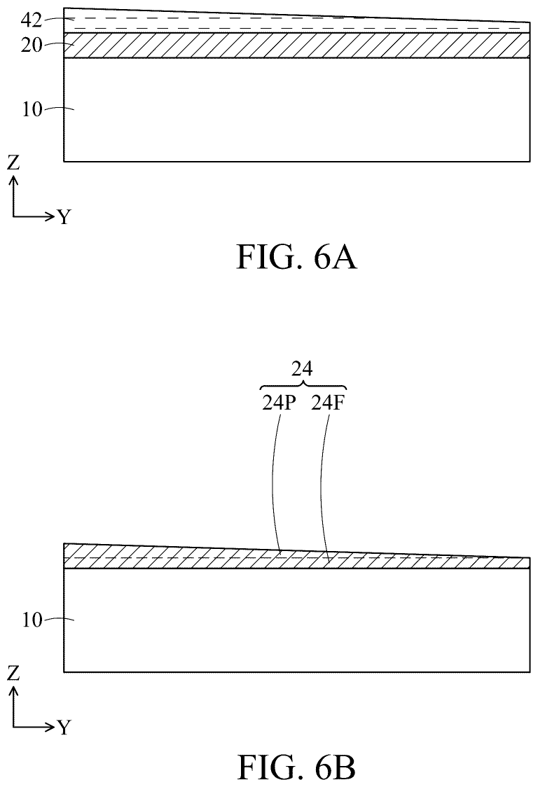

FIG. 6A to FIG. 6B are partial cross-sectional views illustrating the method for manufacturing the optical waveguide structure 102 at various stages according to some other embodiments of the present disclosure. For example, the step shown in FIG. 6A may be continued after the step shown in FIG. 4B, but the present disclosure is not limited thereto. Similarly, some steps during the method for manufacturing the optical waveguide structure 102 and/or some components of the optical waveguide structure 102 have been omitted in FIG. 6A to FIG. 6B for the sake of brevity.

As shown in FIG. 6A, a mask layer 42 is formed on the dielectric material 20. In this embodiment, the mask layer 42 has one slope surface. The material and the forming method of the mask layer 42 may be similar to those of the mask layer 40, which will not be repeated here again. Then, as shown in FIG. 6B, an etching process is performed to etch the dielectric material 20 to form the dielectric layer 24 using the mask layer 42 as an etch mask, so that the dielectric layer 24 includes a flat portion 24F and a gradient portion 24G disposed on the flat portion 22F. Next, as shown in FIG. 5, a waveguide layer 32 is formed on the dielectric layer 24 to form the optical waveguide structure 102.

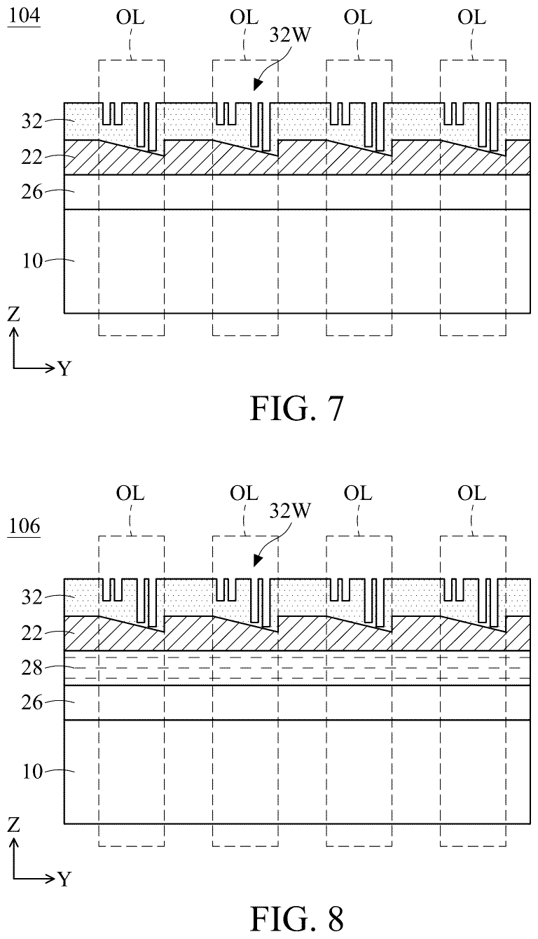

FIG. 7 and FIG. 8 are partial cross-sectional views illustrating the optical waveguide structure 104 and the optical waveguide structure 106 according to some other embodiments of the present disclosure. The top view of the optical waveguide structure 104 or the optical waveguide structure 106 may be similar to the top view of the optical waveguide structure 100. That is, FIG. 7 or FIG. 8 may also be a partial cross-sectional view of the optical waveguide structure 100 along line A-A′ in FIG. 1, but the present disclosure is not limited thereto. Similarly, some components of the optical waveguide structure 104 and the optical waveguide structure 106 have been omitted in FIG. 7 and FIG. 8 for the sake of brevity.

As shown in FIG. 7, the optical waveguide structure 104 may have a similar structure to the optical waveguide structure 100 shown in FIG. 2. In this embodiment, the main difference is that the optical waveguide structure 104 further includes an additional layer 26 disposed between the substrate 10 and the dielectric layer 22. In some embodiments, the additional layer 26 includes an adhesion layer, a flatness layer, or a refractive index matching layer.

For example, the adhesion layer may increase component adhesion, so that the layers in the optical waveguide structure 104 may be not easy to delamination/peeling, even after a reliability test (e.g., high temperature test, high humidity test and/or high pressure test). Moreover, since the quality of the substrates 10 from different manufacturers may be not necessarily the same, the flatness layer may be used first to make the surface conditions of the substrates 10 the same, reducing the differences in the substrates 10 themselves, so that subsequent processes may be carried out under the same conditions. Furthermore, since there is not necessarily a material whose refractive index value is close to that of the substrate 10 or the waveguide layer 32, the refractive index matching layer may reduce the problems that may be caused by the refractive index difference.

As shown in FIG. 8, the optical waveguide structure 106 may have a similar structure to the optical waveguide structure 104 shown in FIG. 7. In this embodiment, the main difference is that the optical waveguide structure 106 further includes another additional layer 28 disposed between the additional layer 26 and the dielectric layer 22. Similarly, the additional layer 28 includes an adhesion layer, a flatness layer, or a refractive index matching layer. Moreover, the optical waveguide structure 104 shown in FIG. 7 or the optical waveguide structure 106 shown in FIG. 8 may be divided into a plurality of optical lens OL according to the multi-ridged waveguide elements 32W.

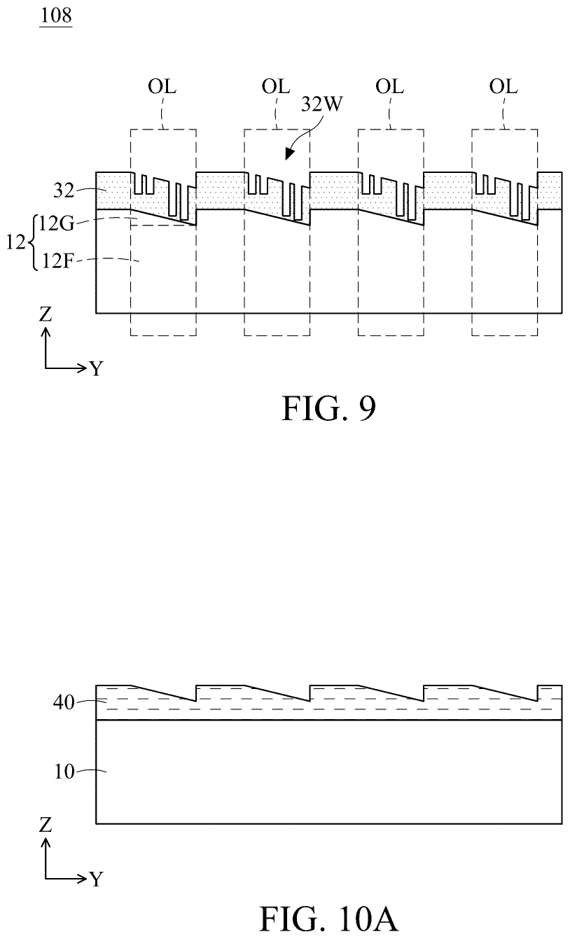

FIG. 9 is a partial cross-sectional view illustrating the optical waveguide structure 108 according to some other embodiments of the present disclosure. The top view of the optical waveguide structure 108 may be similar to the top view of the optical waveguide structure 100. That is, FIG. 9 may also be a partial cross-sectional view of the optical waveguide structure 100 along line A-A′ in FIG. 1, but the present disclosure is not limited thereto. Similarly, some components of the optical waveguide structure 108 have been omitted in FIG. 9 for the sake of brevity.

As shown in FIG. 9, in some embodiments, the optical waveguide structure 108 includes a substrate 12, the substrate 12 includes a flat portion 12F and gradient portions 12G disposed on the flat portion 12F. The flat portion 12F has a constant thickness, and each gradient portion 12G has a continuously varying thickness. The optical waveguide structure 108 further includes a waveguide layer 32 disposed on the substrate 10, and the waveguide layer 32 includes multiple multi-ridged waveguide elements 32W that correspond to the gradient portions 12G. Similarly, the optical waveguide structure 108 shown in FIG. 9 may be divided into a plurality of optical lens OL according to the multi-ridged waveguide elements 32W, so that each optical lens OL may include a multi-ridged waveguide element 32W that corresponds to one gradient portion, but the present disclosure is not limited thereto.

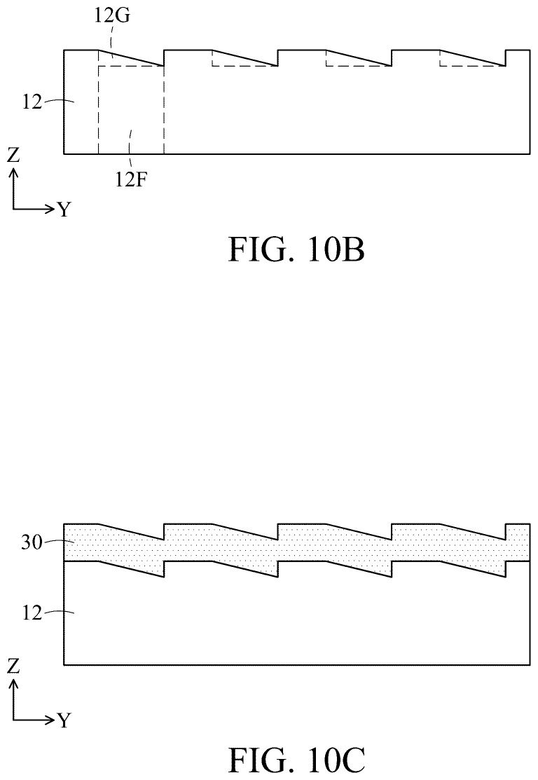

FIG. 10A to FIG. 10C are partial cross-sectional views illustrating the method for manufacturing the optical waveguide structure 108 at various stages according to some other embodiments of the present disclosure. Similarly, some steps during the method for manufacturing the optical waveguide structure 108 and/or some components of the optical waveguide structure 108 have been omitted in FIG. 10A to FIG. 10C for the sake of brevity.

As shown in FIG. 10A, a mask layer 40 is formed on the substrate 10. In this embodiment, the mask layer 40 has a plurality of slope surfaces. Then, as shown in FIG. 10B, an etching process is performed to etch the substrate 10 to form the substrate 12 using the mask layer 40 as an etch mask, so that the substrate 12 includes a flat portion 12F and gradient portions 12G disposed on the flat portion 12F. As shown in FIG. 10B, in this embodiment, the flat portion 12F has a constant thickness, each gradient portion 12G has a continuously varying thickness and defines a slope surface.

Then, as shown in FIG. 10C, a waveguide material 30 is formed on the substrate 12. Next, as shown in FIG. 9, a patterning process is performed on the waveguide material 30 to form at least one multi-ridged waveguide element 32W, thereby forming the optical waveguide structure 108. For example, the patterning process includes forming a mask layer (not illustrated) on the waveguide material 30, then etching the portion of the deposited material layer that is covered (or not covered) by the mask layer, and forming the multi-ridged waveguide element 32W to form the waveguide layer 32. The examples of materials and formation of the mask layer and the etching process are as described above, which will not be repeated here again.

As noted above, the optical lens according to some embodiments of the present disclosure includes a gradient portion in the dielectric layer or in the substrate, which may effectively control the TTV of the waveguide layer for improving the optical efficiency. In may also avoid expensive polishing steps or other less-efficient methods for controlling the TTV of the waveguide material after the formation of the waveguide layer.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. An optical lens, comprising:
a substrate;
a dielectric layer disposed on the substrate and comprising a flat portion and a gradient portion disposed on the flat portion, wherein the flat portion has a constant thickness, and the gradient portion has a continuously varying thickness; and
a waveguide layer disposed on the dielectric layer, wherein the waveguide layer comprises a multi-ridged waveguide element that corresponds to the gradient portion.

2. The optical lens as claimed in claim 1, wherein the gradient portion defines a slope surface, and a dihedral angle between the slope surface and a top surface of the substrate is greater than 0.001° and less than 0.01°.

3. The optical lens as claimed in claim 1, wherein a maximum thickness of the gradient portion is within a range of 1 μm to 2 μm.

4. The optical lens as claimed in claim 1, wherein a thickness of the flat portion is within a range of 1 μm to 18 μm.

5. The optical lens as claimed in claim 1, wherein the ratio of a refractive index of the dielectric layer to a refractive index of the substrate is within a range of 0.95 to 1.05.

6. The optical lens as claimed in claim 1, wherein a refractive index of the dielectric layer is within a range of 1.5 to 2.8.

7. The optical lens as claimed in claim 1, wherein in a cross-sectional view, a width of the gradient portion is within a range of 40 mm to 60 mm.

8. The optical lens as claimed in claim 1, further comprising:
at least one additional layer disposed between the substrate and the dielectric layer.

9. The optical lens as claimed in claim 8, wherein the at least one additional layer comprises an adhesion layer, a flatness layer, or a refractive index matching layer.

10. The optical lens as claimed in claim 1, wherein the multi-ridged waveguide element is a surface relief grating or a meta-lens.

11. The optical lens as claimed in claim 1, wherein the multi-ridged waveguide element comprises protrusions, and the protrusions form cavities.

12. The optical lens as claimed in claim 11, wherein in a cross-sectional view, a width of each of the protrusions is within a range of 100 nm to 300 nm.

13. The optical lens as claimed in claim 11, wherein in a cross-sectional view, a pitch of the protrusions is within a range of 200 nm to 600 nm.

14. The optical lens as claimed in claim 11, wherein a depth of the cavities is within a range of 20 nm to 200 nm.

15. The optical lens as claimed in claim 1, wherein a thickness of the substrate is within a range of 0.2 mm to 1 mm.

16. The optical lens as claimed in claim 1, wherein a refractive index of the substrate is within a range of 1.5 to 2.8.

17. An optical lens, comprising:
a substrate comprising a flat portion and a gradient portion disposed on the flat portion, wherein the flat portion has a constant thickness, and the gradient portion has a continuously varying thickness;
a waveguide layer disposed on the substrate, wherein the waveguide layer comprises a multi-ridged waveguide element that corresponds to the gradient portion.

18. An optical waveguide structure, comprising:
a substrate;
a dielectric layer disposed on the substrate and comprising a flat portion and at least one gradient portion disposed on the flat portion, wherein the flat portion has a constant thickness, and the at least one gradient portion has a continuously varying thickness; and
a waveguide layer disposed on the dielectric layer, wherein the waveguide layer comprises multi-ridged waveguide elements.

19. The optical waveguide structure as claimed in claim 18, wherein the at least one gradient portion comprises gradient portions, and the multi-ridged waveguide elements correspond to the gradient portions.

20. The optical waveguide structure as claimed in claim 18, wherein a maximum thickness of the gradient portion is within a range of 8 μm to 10 μm.
